(19) United States
(12) Patent Application Publication
(10) Pub. No.: US 2025/0083164 A1
(43) Pub. Date: Mar. 13, 2025

(54) FLUID DISPENSING DEVICE

(71) Applicant: Rust-Oleum Corporation, Vernon Hills, IL (US)

(72) Inventor: Adam Peter Morrison, Belvidere, IL (US)

(21) Appl. No.: 18/830,878

(22) Filed: Sep. 11, 2024

Related U.S. Application Data
(60) Provisional application No. 63/537,602, filed on Sep. 11, 2023.

(51) Int. Cl. B05B 11/00; B05B 11/10

(52) U.S. Cl. CPC B05B 11/0081; B05B 11/0062; B05B 11/1002

(57) ABSTRACT

Described herein is a fluid dispensing device that enables rapid fluid mixing of separate solutions prior to dispensing. Also described herein are methods of using and manufacturing the fluid dispensing device. The fluid dispensing device is useful with a variety of reactive and/or concentrated formulations, including cleaning formulations.

### CROSS-REFERENCE TO RELATED APPLICATION

This application claims the benefit of, and priority to, U.S. Provisional Patent Application Ser. No. 63/537,602, filed on Sep. 11, 2023, the disclosure of which is hereby incorporated by reference in its entirety.

### FIELD OF DISCLOSURE

This disclosure is directed to a fluid dispensing device that enables rapid fluid mixing of separate solutions prior to dispensing. The fluid dispensing device is useful with a variety of reactive and/or concentrated formulations, including cleaning formulations.

### BACKGROUND

Fluid dispensing devices are well known in the art. Such devices are used to dispense a wide variety of liquids and chemical formulations. However, previous solutions have not been satisfactory for mixing and dispensing multiple liquids.

The present disclosure provides a fluid dispensing device that overcomes this deficiency and enables rapid fluid mixing of separate solutions prior to dispensing. These fluid mixing capabilities are applicable across a broad range of chemical formulations, including reactive and/or concentrated formulations.

### BRIEF DESCRIPTION OF THE DISCLOSURE

In one aspect, provided herein is a fluid dispensing device comprising: a bottle comprising a first compartment comprising a first fluid and a second compartment comprising a second fluid; and a dispensing head comprising: an actuator, a pump comprising a reservoir, a flow chamber comprising a first inlet portion, a second inlet portion, and a metering device that is configured to meter fluid flow; and an outlet portion. The first inlet portion of the flow chamber is fluidically coupled to the first compartment of the bottle by a first dip tube and the second inlet portion of the flow chamber is fluidically coupled to the second compartment of the bottle by a second dip tube.

In another aspect, provided herein is a method of using a fluid dispensing device comprising: a bottle comprising a first compartment comprising a first fluid and a second compartment comprising a second fluid; and a dispensing head comprising: an actuator, a pump comprising a reservoir, a flow chamber comprising a first inlet portion, a second inlet portion, and a metering device that is configured to meter fluid flow; and an outlet portion. The first inlet portion of the flow chamber is fluidically coupled to the first compartment of the bottle by a first dip tube and the second inlet portion of the flow chamber is fluidically coupled to the second compartment of the bottle by a second dip tube. The method comprises actuating the actuator to dispense a dispensing fluid from the fluid dispensing device.

In yet another aspect, provided herein is a method of manufacturing a fluid dispensing device comprising: a bottle comprising a first compartment comprising a first fluid and a second compartment comprising a second fluid; and a dispensing head comprising: an actuator, a pump comprising a reservoir, a flow chamber comprising a first inlet portion, a second inlet portion, and a metering device that is configured to meter fluid flow; and an outlet portion. The first inlet portion of the flow chamber is fluidically coupled to the first compartment of the bottle by a first dip tube and the second inlet portion of the flow chamber is fluidically coupled to the second compartment of the bottle by a second dip tube. The method comprises assembling the bottle and the dispensing head.

### BRIEF DESCRIPTION OF THE DRAWINGS

FIG. 1 is a perspective view of a fluid dispensing device in accordance with the present disclosure;

FIG. 2 is an exploded, perspective view, of the fluid dispensing device of FIG. 1;

FIG. 3A is a perspective view of a dispensing head of the fluid dispensing device of FIG. 1 in accordance with the present disclosure;

FIG. 3B is a perspective view of another embodiment of a dispensing head of the fluid dispensing device of FIG. 1 in accordance with the present disclosure;

FIG. 4 is an exploded view of the dispensing head of FIG. 3;

FIG. 5 is a side, cross-sectional view of the dispensing head of FIG. 3;

FIG. 5A is an enlarged view of the area of detail indicated in FIG. 5;

FIG. 5B is an enlarged view of the area of detail indicated in FIG. 5;

FIG. 6 is a side, cross-sectional view of a lower chamber of the dispensing head of FIG. 3 in accordance with the present disclosure;

FIG. 7 is a side, cross-sectional view of a metering valve insert of the dispensing head of FIG. 3 in accordance with the present disclosure;

FIG. 8 is a side, cross-sectional view of an upper chamber of the dispensing head of FIG. 3 in accordance with the disclosure;

FIG. 9A is a side, exploded view of another embodiment of a dispensing head of the fluid dispensing device of FIG. 1 in accordance with the present disclosure;

FIG. 9B is an enlarged view of a lower chamber and dip tubes of the dispensing head of FIG. 9A;

FIG. 10 is a side, cross-sectional view of a lower chamber of the dispensing head of FIG. 9A in accordance with the present disclosure;

FIG. 11 is a side, cross-sectional view of the lower chamber of FIG. 10 illustrating an air-inlet valve in accordance with the present disclosure;

FIG. 12 is a bottom view of the dispensing head of FIG. 9A;

FIG. 13A is a side, cross-sectional view of the dispensing head of FIG. 3A illustrating an engine of the dispensing head in a first mixing stage in accordance with the present disclosure;

FIG. 13B is a side, cross-sectional view of the dispensing head of FIG. 3A illustrating the engine of the dispensing head in a second mixing stage in accordance with the present disclosure;

FIG. 13C is a side, cross-sectional view of the dispensing head of FIG. 3A illustrating the engine of the dispensing head in a fluid dispensing stage in accordance with the present disclosure;

FIG. 14A is a flow diagram of a method of using a dispensing device provided in accordance with the present disclosure; and

FIG. 14B is a continuation of the flow diagram of FIG. 14.

### DETAILED DESCRIPTION OF THE DISCLOSURE

Fluid dispensing devices in accordance with the present disclosure enable rapid fluid mixing of separate solutions prior to dispensing. Among other benefits, such devices allow application of previously unknown and/or unusable chemical formulations.

There are several particular advantages to the fluid dispensing devices in accordance with the present disclosure. First, they do not require a small orifice to restrict flow of various fluids. Second, backflow of fluid is restricted by fluid captured in the flow chamber. As the whole system is sealed, fluid can only travel forward through the valves and not backwards. Third, mixing of the first fluid and the second fluid takes place in the pump reservoir, and therefore a separate mixing device is not required.

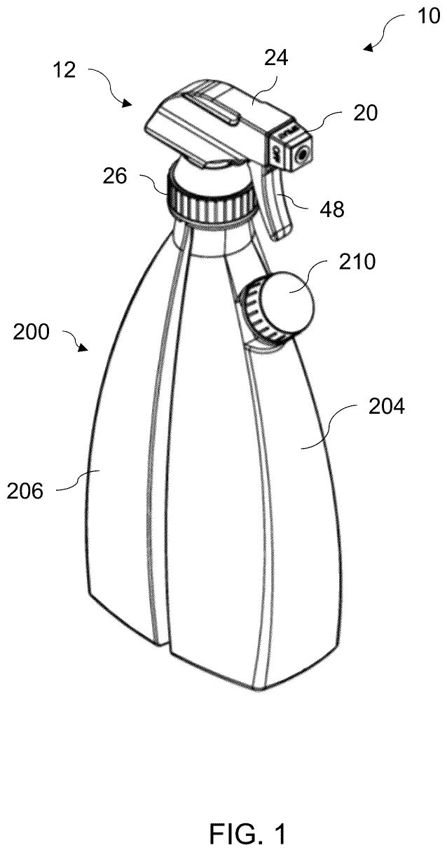

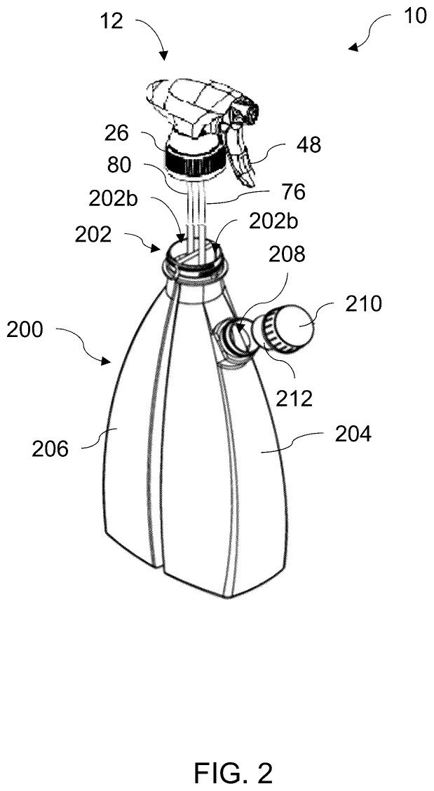

Turning now to the drawings, a fluid dispensing device is illustrated in FIGS. 1 and 2 and generally identified by reference numeral 10. The fluid dispensing device 10 includes a dispensing head 12 that is selectively couplable to a bottle 200, which in embodiments, may be a dual chamber bottle. The dual chamber bottle 200 includes one opening, a dual chamber bottle inlet 202, at the top with a divider between individual openings 202a and 202b into a front bottle chamber 204 and a back bottle chamber 206. The dual chamber bottle 200 also includes a separate opening into the front bottle chamber 204, a single chamber bottle inlet 208, such that the front bottle chamber 204 is accessible separate from the back bottle chamber 206 (e.g., individually accessible). In one non-limiting embodiment, the front bottle chamber 204 may be filled with water, although it is contemplated that the front bottle chamber 204 may be filled with any suitable fluid or compound without departing from the scope of the present disclosure. The dual chamber bottle 200 includes a cap 210 selectively couplable to the single chamber bottle inlet 208 to selectively enclose the single chamber bottle inlet 208. In embodiments, a cap seal 212 may be interposed between the cap 210 and the single chamber bottle inlet 208. It is envisioned that the cap 210 may be selectively couplable to the single chamber bottle inlet 212 using any suitable means, such as threadable engagement, snap fit, friction fit, quarter turn, etc.

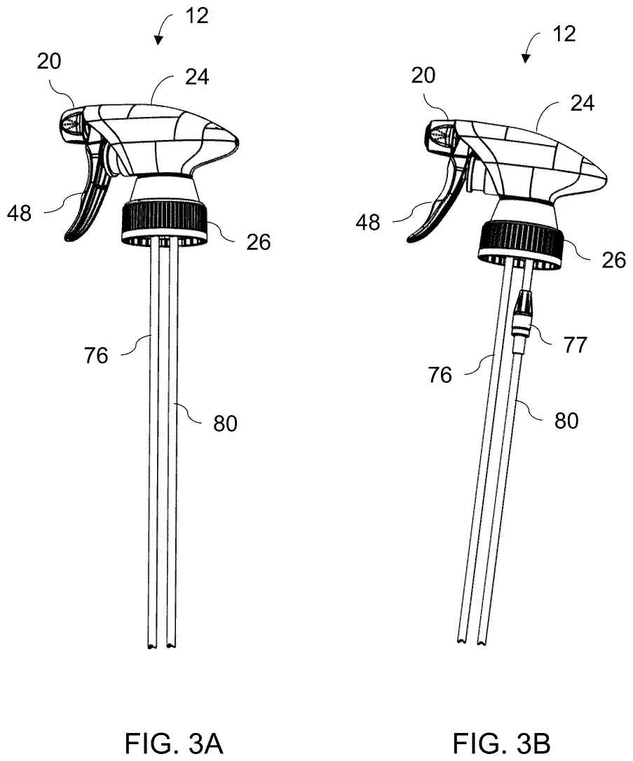

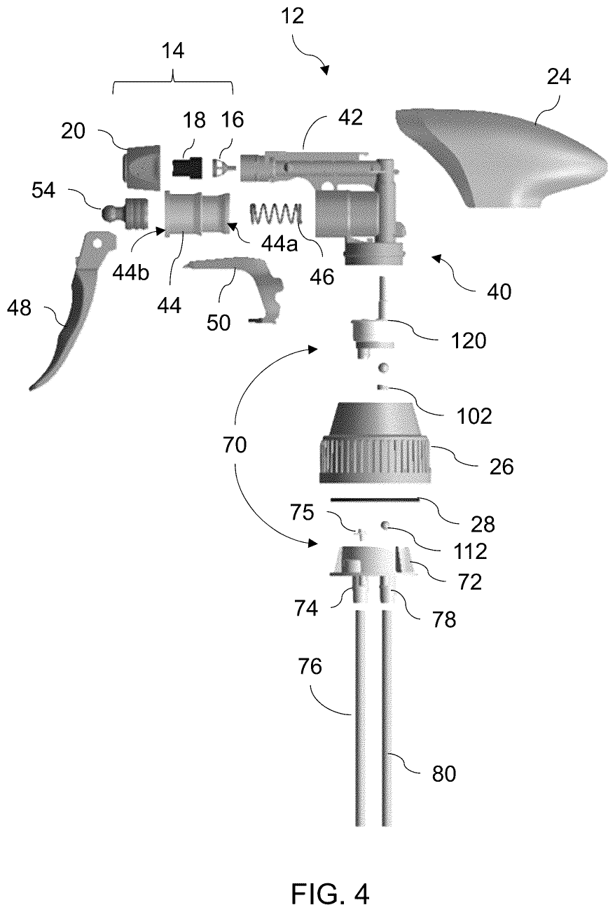

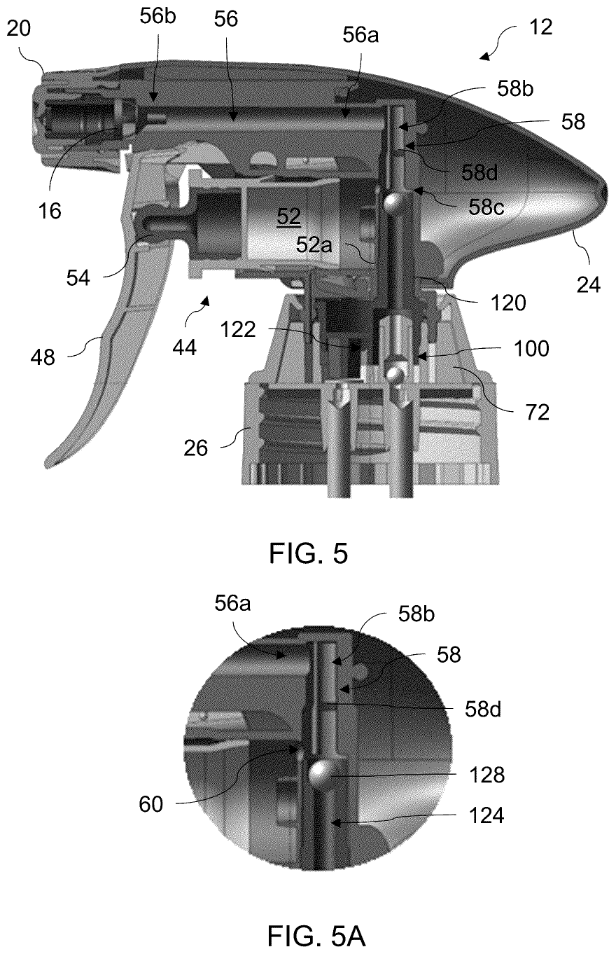

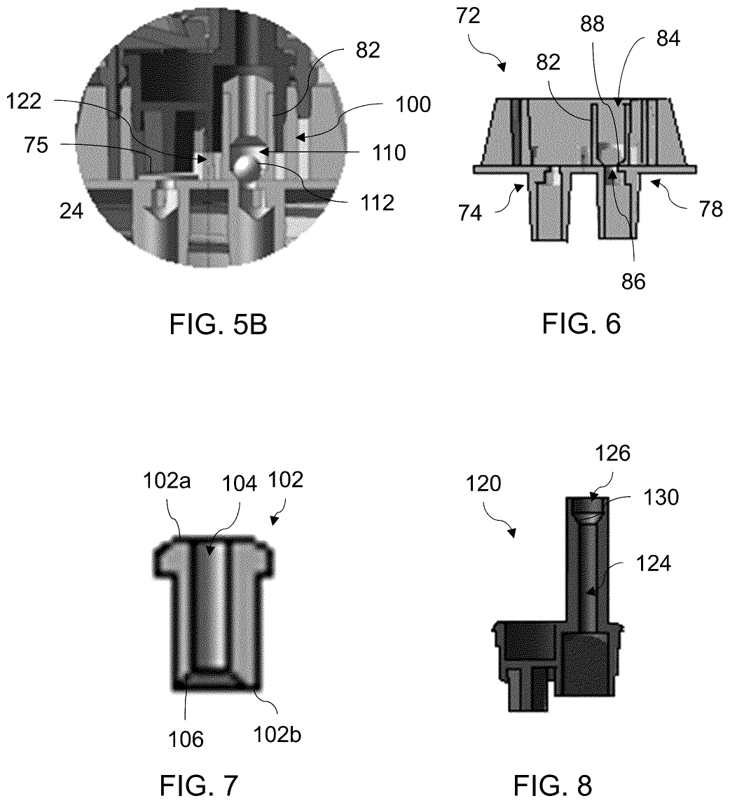

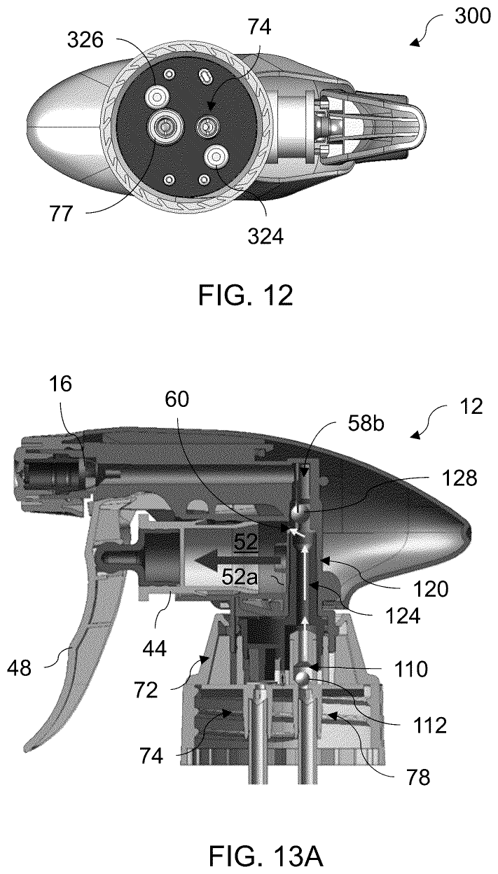

Continuing with FIGS. 1 and 2 and with additional reference to FIGS. 3A-12, the dispensing head 12 includes an outlet portion 14 (FIGS. 4 and 5) including a nozzle valve 16, one or more nozzle inserts 18, and a nozzle 20, although it is contemplated that the outlet portion 14 may include one or more additional components or may omit one or more of the nozzle valve 16, nozzle inserts 18, and nozzle 20 without departing from the scope of the disclosure. In one non-limiting embodiment, the outlet portion 14 includes a water jacket and a foamer. The dispensing head 12 includes a shroud 24 housing an engine or pump 40 fluidly coupled to the outlet portion 14. The engine 40 includes an engine block 42, a piston 44 slidably supported within the engine block 42, a biasing element or spring 46 operably coupled to the piston 44, an actuator or trigger handle 48 operably coupled to the engine block 42 and the piston 44, and a flow chamber 70 operably coupled to and in fluid communication with the engine block 42. In embodiments, the engine 40 includes a retaining clip 50 operably coupled to the engine block 42 and the trigger handle 48. The retaining clip 50 is operably coupled to a portion of the shroud 24 and rotatably supports the trigger handle 48 or otherwise strengthens the interface between engine 40 and the shroud 24. In embodiments, the engine 40 is combined with the flow chamber 70 in a ratcheting neck or screw cap 26. The engine 40 and/or the mixing chamber 70 is sealed to the dual chamber bottle 200 with a seal gasket 28 placed over both of a first dip tube 76 and a second dip tube 80, and the ratcheting neck 26 that interfaces with the dual chamber bottle inlet 202.

The engine block 42 includes a piston chamber or reservoir 52 configured to slidably receive the piston 44 (FIG. 5). The piston 44 is translatably supported within the reservoir 52 and cooperates with the reservoir 52 to provide a seal or otherwise retain fluid within the reservoir 52. The spring 46 is disposed within the reservoir 52 and interposed between a first end portion 44a of the piston 44 and an inner wall 52a of the reservoir 52. In this manner, the spring 46 biases the piston 44 in a direction away from the internal wall 52a and provides a biasing force or resistance against translation of the piston 44 towards the inner wall 52a. Although generally illustrated as a compression coil spring, it is envisioned that the spring 46 may be any suitable biasing element without departing from the scope of the present disclosure, such as for example, a pneumatic spring, a polymer spring, Belleville washers, an extension spring, a leaf spring, etc.

The piston 44 includes or otherwise defines a ball socket 54 extending from a second end portion 44b of the piston 44 in a direction away from the inner wall 52a of the reservoir 52. It is envisioned that the ball socket 54 may be a separate component that is joined to the piston 44 using any suitable means or may be integral with the piston 44 (e.g., the piston 44 and the ball socket 54 are formed as a single component). The trigger handle 48 is rotatably supported by the engine block 42 and/or the retaining clip 50 and is operably coupled to the ball socket 54. As will be described in further detail hereinbelow, actuation of the trigger handle 48 transfers a force from the trigger handle 48 to the ball socket 54 and urges the piston 44 towards the inner wall 52a of the reservoir 52. The biasing force of the spring 46 resists translation of the piston 44 towards the inner wall 52a until the force exerted on the ball socket 54 is greater than the biasing force of the spring 46, at which point continued actuation of the trigger handle 48 causes the piston 44 to compress the spring 46 and translate towards the inner wall 52a.

With continued reference to FIGS. 5 and 5A, the engine block 42 defines an outlet channel 56 extending between an inlet 56a and an opposite outlet 56b. The outlet channel 56 is operably coupled to and in fluid communication with the outlet portion 14. In this manner, the nozzle valve 16 is translatably supported within the outlet 56b of the outlet channel 56 between a first, closed position inhibiting the flow of air or fluid through the nozzle 20 and into the outlet channel 56 and a second, open position permitting the flow of fluid from the outlet channel 56 to the nozzle 20. The engine block 42 defines an inlet channel 58 extending between an inlet 58a and an opposite outlet 58b. The outlet 58b is in fluid communication with the inlet 56a of the outlet channel 56 to permit flow of fluid from the inlet channel 58 into the outlet channel 56. As will be described in further detail hereinbelow, the inlet 58a of the inlet channel 58 is in fluid communication with the upper chamber 120 of the flow chamber 70. The engine block 42 defines a port 60 (FIG. 5A) fluidly coupling the reservoir 52 to the inlet channel 58. The port 60 is defined at a location that selectively enables fluid to be expelled from the reservoir 52 into the inlet channel 58 and selectively enables fluid to be drawn into the reservoir 52 from the inlet channel 58.

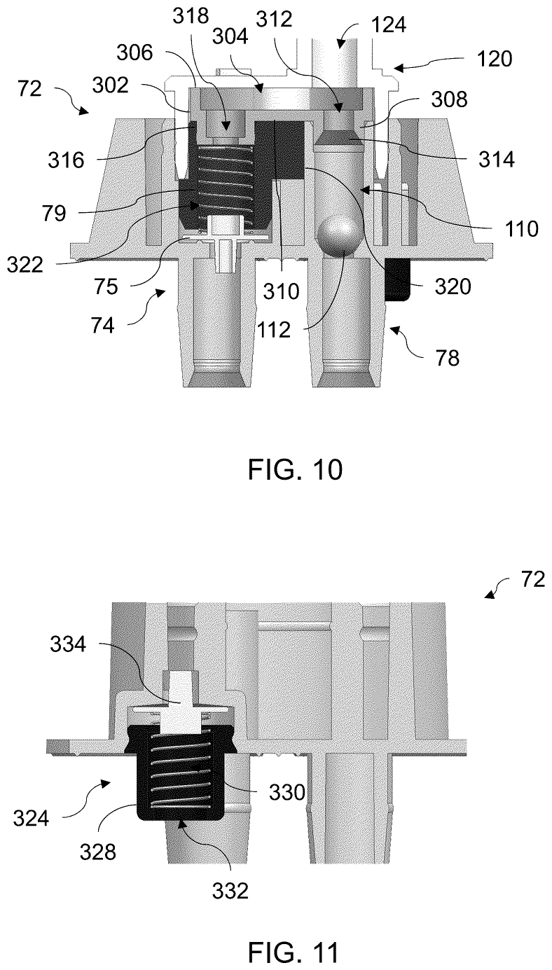

Referring back to FIG. 4 and with additional reference to FIGS. 5A-7, the flow chamber 70 includes a lower chamber 72, a metering device 100, and an upper chamber 120 operably coupled to the lower chamber 72. The lower chamber 72 includes a first inlet portion 74 operably and fluidly coupled to a first dip tube 76 and a second inlet portion 78 operably and fluidly coupled to a second dip tube 80 (FIGS. 4 and 5). The first dip tube 76 is selectively receivable within the front bottle chamber 204 (FIG. 2) to fluidly coupled the first inlet portion 74 to the front bottle chamber 204. In embodiments, the first inlet portion 74 includes a backflow valve 75 (FIG. 5B) configured to transition from a first, closed position where fluid is inhibited from flowing from the lower chamber and back into the front bottle chamber 204 to a second, open position where fluid is permitted to flow from the front bottle chamber 204 into the lower chamber 72. In embodiments, the backflow valve 75 may include a biasing element 79 (FIG. 10) interposed between the backflow valve 75 and the upper chamber 120 to bias or otherwise urge the backflow valve 75 to the closed position.

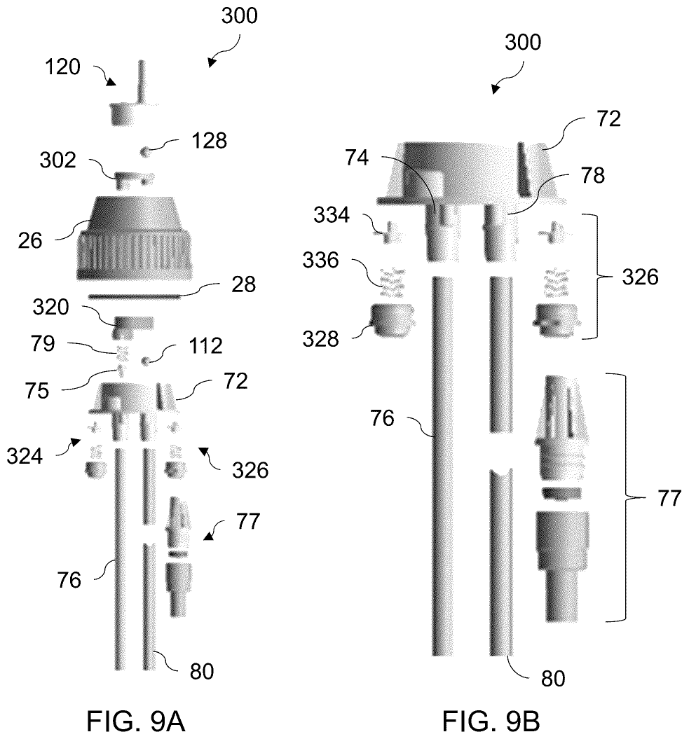

The second dip tube 80 is selectively receivable within the back bottle chamber 206 (FIG. 2) to fluidly couple the second inlet portion 78 to the back bottle chamber 206. In embodiments, a one-way valve or check valve 77 (FIGS. 3B, 9A, and 9B) may be operably coupled to the second dip tube 80 to permit the second fluid to be drawn from the back bottle chamber 206 into the lower chamber 72 and inhibit the flow of fluid from the lower chamber 72 back into the back bottle chamber 206. The lower chamber 72 defines an annular boss 82 extending in a direction away from the second inlet portion 78 and including a hollow interior portion or channel 84. The second inlet portion 78 is in fluid communication with the channel 84 via an aperture 86. The channel 84 defines a first sealing surface 88 having an inner dimension that transitions from the inner dimension of the channel 84 to the inner dimension of the aperture 86, which is smaller than the inner dimension of the channel 84. Although generally illustrated as including a frusto-conical profile, it is envisioned that the first sealing surface 88 may include any suitable profile against which a ball 112 of the metering device 100 can abut and form a seal.

The metering device 100 includes a metering valve insert 102, a metering chamber 110, and a valve 112, which in embodiments, may be a ball valve. The metering valve insert 102 is disposed within the channel 84 of the lower chamber 72 and includes a lumen 104 extending through opposed upper and lower surfaces 102a, 102b (FIG. 7). The lower surface 102b of the metering valve insert 102 defines a second sealing surface 106 having an inner dimension that transitions from the inner dimension of the lumen 104 to the inner dimension of the channel 84, which is larger than the inner dimension of the lumen 104. Although generally illustrated as having a profile that is complimentary to the profile of the first sealing surface 88, it is envisioned that the second sealing surface 106 may include any suitable profile against which the ball 112 of the metering device 100 can abut and form a seal.

The metering chamber 110 is defined between the first sealing surface 88 and the second sealing surface 106. As can be appreciated, a volume of the metering chamber 110 is defined by the inner dimension of the channel 84 and the distance between each of the first sealing surface 88 and the second sealing surface 106. In embodiments, the volume of the metering chamber 110 is dependent upon a type of fluid or cleaning solution is retained within the back bottle chamber 206 (e.g., a second fluid) and the type of mixture (e.g., an amount of dilution) needed and is configured to retain a predetermined amount of the second fluid. It is envisioned that the volume of the metering chamber 110 may be determined based upon the properties of the second fluid, such as for example, a viscosity and/or density, the inner dimensions and length of each of the aperture 86 and the lumen 104, and dimensions, shape, and other properties of the valve 112.

The valve 112, which in the exemplary embodiment is a ball, is slidably disposed within the metering chamber 110. In this manner, the outer dimension of the ball 112 is equal to or less than the inner dimension of the metering chamber 110 and the inner dimension of each of the aperture 86 and the lumen 104 is less than the outer dimension of the ball 112. The ball 112 is configured to transition between a first position where the ball 112 abuts the first sealing surface 88 and a second position where the ball 112 abuts the second sealing surface 106. In embodiments, the volume of the metering chamber 110 is defined taking into account a volume displaced by the ball 112 to ensure a desired amount of second fluid is drawn into the metering chamber 110.

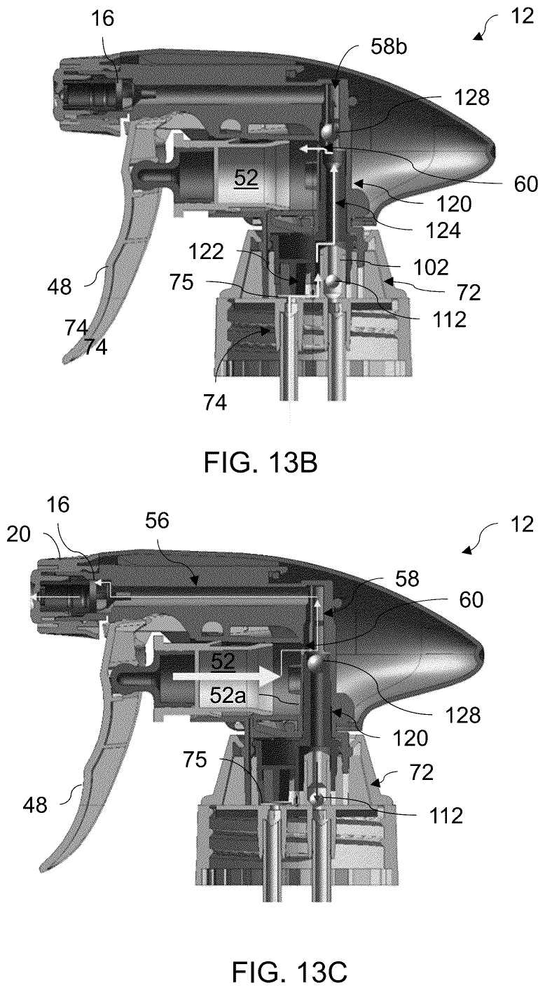

In operation, when the ball 112 is disposed in the first position (FIG. 13A), the second fluid is permitted to be drawn into the second dip tube 80 from the back bottle chamber 206 and flow through the lumen 104 into the metering chamber 110. Continued drawing of the second fluid into the metering chamber 110 causes the second fluid to flow through the aperture 86 and into the lower chamber 72. Further drawing of the second fluid into the metering chamber 110 causes the second fluid to urge the ball 112 towards the second sealing surface 106 and effectuate a seal between the ball 112 and the second sealing surface 106, inhibiting additional second fluid from flowing through the aperture 86 (FIG. 13B). After a predetermined amount of second fluid is drawn into the reservoir 52 and/or a predetermined a predetermined pressure within the reservoir 52 is reached, the ball 112 is permitted to fall or otherwise translate towards the first sealing surface 88 and create a seal against the first sealing surface 88. As can be appreciated, the pressure within the mixing chamber 110, cooperating with the density and/or weight of the ball 112, exerts a force on the ball 112 to urge the ball 112 into the sealing surface 88 to inhibit or otherwise prevent fluid from backflowing or otherwise flowing back through the aperture 88 and into the back bottle chamber 206 (FIG. 13C). Although generally described as being a ball, it is envisioned that the valve 112 may be any suitable valve having any suitable shape, such as sphere shaped, rod-shaped, disc-shaped, etc. and/or combinations thereof that is capable of translating within the metering chamber and forming a seal against each of the first sealing surface 88 and the second sealing surface 106. In embodiments, the valve 112 may be selected from the group consisting of check valves, ball valves, duckbill valves, and combinations thereof.

The ball 112 includes a density that is greater than or otherwise denser than the density of the second fluid or dispensing fluid. It is envisioned that the density of the ball 112 may be determined based upon the properties of the second fluid, such as viscosity and/or density. As can be appreciated, a speed or velocity of the ball 112 translating within the metering chamber 110, and the quality of seal the ball 112 forms against each of the first sealing surface 88 and the second sealing surface 106. It is contemplated that ball 112 may be formed from any suitable material that is compatible with the first fluid (e.g., water) and the second fluid. In embodiments, the ball 112 may be formed from a material selected from the group consisting of rubbers, natural rubbers, synthetic rubbers, polymers, and combinations thereof. In one non-limiting embodiment, the valve 112 is spring-loaded.

Continuing with FIGS. 4-8, the upper chamber 120 cooperates with the lower chamber 72 to define an inlet chamber 122 (FIGS. 5 and 5B). The inlet chamber 122 is in fluid communication with the first inlet portion 74 and the lumen 104 of the mixing valve insert 102. In this manner, upon actuation of the trigger handle 48, the second fluid is drawn from the second bottle chamber 206, into the metering chamber 110, and into the inlet chamber 122. As the metering device 100 closes (e.g., the ball 112 abuts the second sealing surface 106), the flow of the second fluid through the metering device 100 is reduced or otherwise stopped and the first fluid is drawn from the front bottle chamber 204 into the inlet chamber 122.

The upper chamber 120 defines a bore 124 (FIGS. 5, 5A, and 8) in fluid communication with the inlet chamber 122 and the inlet channel 58 of the engine block 42. The bore 124 defines a recess or counterbore 126 (FIG. 8) adjacent to the inlet channel 58. The recess 126 defines an inner dimension for slidably receiving an inlet valve or ball 128 (FIG. 5A). The recess 126 defines a third sealing surface 130 (FIG. 8) having an inner dimension that transitions from the inner dimension of the recess 126 to an inner dimension of the bore 124, which is less than the outer dimension of the ball 128. Although generally illustrated as including a frusto-conical profile, it is envisioned that the third sealing surface 130 may include any suitable profile against which the ball 128 may abut and form a seal. The third seal 130 is disposed at a position where the ball 128 is below or otherwise interposed between the port 60 of the engine block 42 and the inlet chamber 122 (FIG. 5A).

The inlet 58a of the inlet channel 58 includes a counterbore 58c having an inner dimension that is complimentary to the inner dimension of the recess 126 of the upper chamber 120 (FIG. 5A). In this manner, the ball 128 is permitted to translate from the recess 126 into the counterbore 58c. The counterbore 58c defines a fourth sealing surface 58d having an inner dimension that transitions from the inner dimension of the counterbore 58c to the inner dimension of the inlet channel 58, which is less than the outer dimension of the ball 128. Although generally illustrated as having a profile that is complementary to the profile of the third sealing surface 130, it is envisioned that the fourth sealing surface 58d may include any suitable profile against which the ball 128 can abut and form a seal. The fourth sealing surface 58d is disposed at a position where the ball 128 is above or otherwise interposed between the port 60 and the inlet 56a of the outlet channel 56.

The ball 128 is transitionable between a first, open position, and a second closed position. With the ball 128 disposed in the first, open position, the ball 128 forms a seal against the fourth sealing surface 58d to permit the flow of fluid through the bore 124 of the upper chamber 120, through the port 60, and into the reservoir 52, and inhibit the flow of fluid through the outlet channel 56 (FIG. 13A). With the ball 128 disposed in the second, closed position, the ball 128 forms a seal against the third sealing surface 130 to permit the flow of fluid from the reservoir 52, through the port 60, and through the outlet channel 56 and be expelled through the outlet portion 14 and inhibit the flow of fluid into the bore 124 of the upper chamber (FIG. 13C).

Turning to FIGS. 9A-12, another embodiment of a dispensing head is illustrated and generally identified by reference numeral 300. The dispensing head 300 is substantially similar to the dispensing head 12 and therefore, only the differences therebetween will be described in detail herein in the interest of brevity.

The dispensing head 300 includes a metering valve plate 302 interposed between the upper chamber 120 and the lower chamber 72 (FIG. 10). In the exemplary embodiment, the metering valve plate 302 replaces the metering valve insert 102. The metering valve plate 302 defines a counterbore 304 through an upper portion 306 that is in fluid communication with the bore 124 of the upper chamber 120. The metering valve plate 302 defines a first boss 308 extending from a lower portion 310 that is generally aligned with and receivable within a portion of the channel 84 of the lower chamber 72 to define the metering chamber 110. A through-hole 312 is defined in the first boss 308 through the upper portion 306 and the lower portion 310 fluidly coupling the metering chamber 110 to the counterbore 304 and the bore 124 of the upper chamber 120. A fifth sealing surface 314 is defined on the first boss 308 having an inner dimension that transitions from the inner dimension of the channel 84 to an inner dimension of the through-hole 312, which is less than the outer dimension of the ball 112 of the metering device 100. Although generally illustrated as having a profile that is complementary to the profile of the first, second, third, and/or fourth sealing surfaces 88, 106, 130, 58d, it is envisioned that the fifth sealing surface 314 may include any suitable profile against which the ball 112 may abut and form a seal.

The metering valve plate 302 includes a second boss 316 extending from the lower portion 310 that is generally aligned with the first inlet portion 74. The second boss 316 includes an aperture 318 fluidly coupling the first inlet portion 74 to the counterbore 304. As can be appreciated, an inner dimension of the aperture 318 may be selected based upon the design needs of the dispensing head 300. The biasing element 79 is interposed between the metering valve plate 302 and the backflow valve 75 to bias or otherwise urge the backflow valve 75 to the closed position. Although generally illustrated as a compression coil spring, it is envisioned that the biasing element 79 may be any suitable biasing element, such as for example, a polymer spring, a pneumatic spring, Belleville washers, an extension springs, etc., and combinations thereof without departing from the scope of the present disclosure. In embodiments, the dispensing head 300 may include a biasing element guide 320 interposed between the mixing valve plate 302 and the backflow valve 75. The biasing element guide 320 includes a bore 322 for receiving or otherwise retaining the biasing element 79, inhibiting the biasing element 79 from becoming dislodged or otherwise misaligned with the backflow valve 75.

The dispensing head 300 includes one or more air inlet valves 324 operably coupled to the lower chamber 72. In one non-limiting embodiment, the dispensing head 300 includes a first air inlet valve 324 in fluid communication with the front bottle chamber 204 and a second air inlet valve 326 in fluid communication with the back bottle chamber 206. Each air inlet valve 324 is substantially similar to one another and therefore only the first air inlet valve 324 will be described in detail herein in the interest of brevity. The air inlet valve 324 includes an air inlet valve cap 328 operably coupled to the lower chamber 72. The air inlet valve cap 328 defines an interior cavity 330 and a perforation 332 enabling fluid to flow into and out of the interior cavity 330. The air inlet valve 324 includes a valve 334 and a biasing element 336 received within the interior cavity 330 and interposed between the valve 334 and the air inlet valve cap 328. As can be appreciated, the biasing element biases or otherwise urges the valve 334 towards the lower chamber 72 and towards a first, closed position to inhibit fluid (e.g., the first fluid) from flowing into the lower chamber 72. In operation, the air inlet valve 324 permits air to flow into the front bottle chamber 204 and inhibit the first fluid from flowing into the lower chamber 72. It is envisioned that the valve 334 may be any valve that is configured to prevent fluidic backflow, and in embodiments, may be selected from the group consisting of check valves, ball valves, duckbill valves, and combinations thereof. In some embodiments, the valve 334 comprises a material selected from the group consisting of rubbers, natural rubbers, synthetic rubbers, polymers, and combinations thereof.

With reference to FIGS. 13A-13C, in operation, as the actuator or trigger handle 48 returns to an initial, un-actuated position via the spring 46, the trigger handle 48 urges or otherwise pulls the piston 44 in a direction away from the inner wall 52a of the reservoir 52 (FIG. 9A). With the nozzle valve 16 disposed in a closed position, air is inhibited from entering the outlet channel 56, enabling a vacuum to be drawn or otherwise created within the reservoir 52. The vacuum within the reservoir 52 causes the inlet valve 128 to transition to the open position with the ball 128 sealed against the fourth sealing surface 58d and the port 60 in fluid communication with the upper chamber 120. The vacuum within the reservoir 52 draws the second fluid from the back bottle chamber 106 into the metering chamber 102, which causes the ball 104 of the metering device 100 to begin to transition from the first position to the second position. Continued vacuum drawn within the reservoir 52 draws the second fluid from the inlet chamber 122, through the port 60, and into the reservoir 52. Further vacuum drawn within the reservoir 52 causes the ball 104 of the metering device 100 to abut the second sealing surface 94 of the metering valve insert 90 and inhibit the flow of additional second fluid into the inlet chamber 122 while enabling additional first fluid to be drawn from the front bottle chamber and into the reservoir 52. In this manner, a predetermined amount of second fluid is drawn into the reservoir 52 to dilute or otherwise form a desired mixture of first and second fluids or dispensing fluid. After a predetermined pressure is reached or a predetermined volume of dispending fluid is received within the reservoir 52, the vacuum within the reservoir 52 is reduced or otherwise stopped, enabling the backflow valve 75 to transition to the closed position, inhibiting the flow of fluid back into the front bottle chamber 104, and enabling the ball 104 of the metering device 100 to transition to the first position, inhibiting the flow of fluid back into the second bottle chamber 106. Additionally, the ball 128 is permitted to transition from the open position to the closed position, where the ball 128 seals against the third sealing surface 130 and the port is in fluid communication with the outlet channel 56. With the trigger handle 48 returned to the unactuated position, the trigger handle 48 may be actuated or otherwise depressed to urge the piston 44 towards the inner wall 52a of the reservoir 52 and dispense fluid through the nozzle 20, enabling the first fluid and the second fluid to be sequentially pumped or otherwise drawn into the reservoir 52. As can be appreciated, it is not necessary for the trigger handle 48 to be disposed in the unactuated position before actuating the trigger handle 48 again. It is envisioned that the above-described operation may be performed any number of times without departing from the scope of the disclosure.

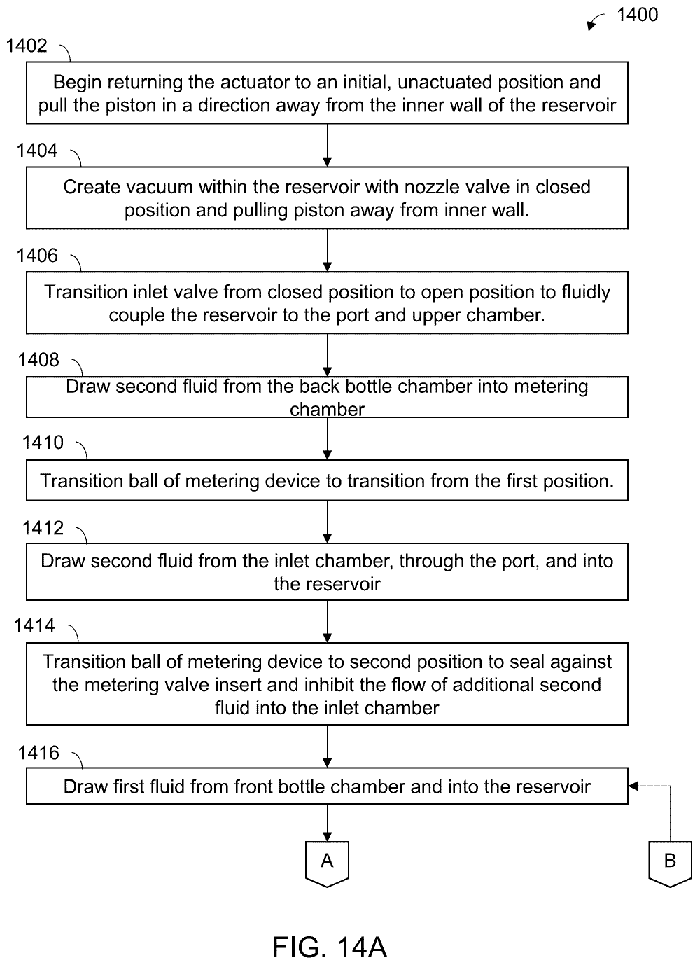

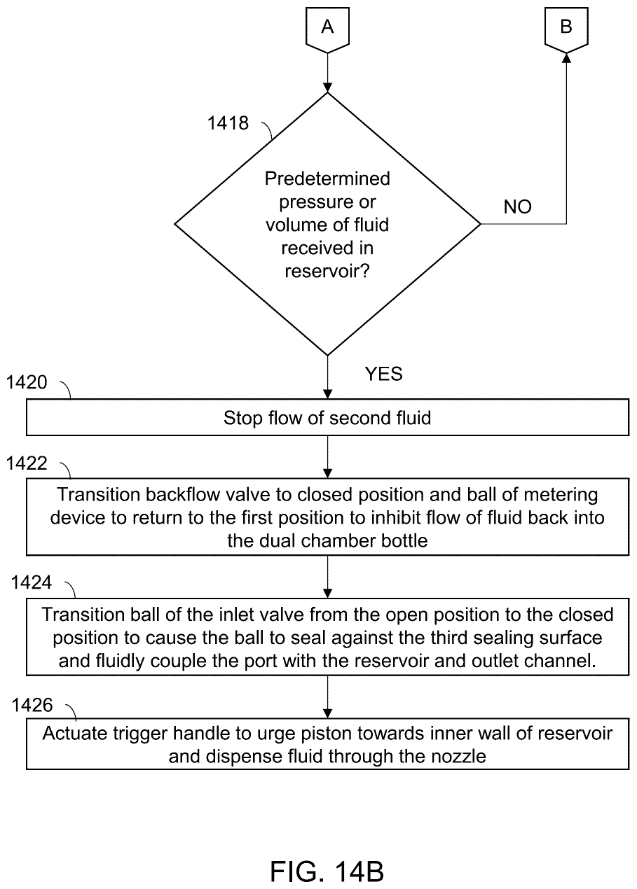

Turning to FIGS. 14A and 14B, a method of using a fluid dispensing device is illustrated and generally identified by reference numeral 1400. The actuator or trigger handle begins returning 1402 to an initial, un-actuated position via the spring and urges or otherwise pulls the piston in a direction away from the inner wall of the reservoir. With the nozzle valve disposed in a closed position, air is inhibited from entering the outlet channel, enabling a vacuum to be drawn or otherwise created 1404 with the reservoir. The vacuum within the reservoir causes the inlet valve to transition 1406 to the open position with the ball sealed against the fourth sealing surface and the port in fluid communication with the upper chamber. The vacuum within the reservoir draws 1408 the second fluid from the back bottle chamber into the metering chamber, which causes the ball of the metering device to begin to transition 1410 from the first position to the second position. Continued vacuum drawn within the reservoir draws 1412 the second fluid from the inlet chamber, through the port, and into the reservoir. Further vacuum drawn within the reservoir causes the ball of the metering device to abut 1414 the second sealing surface of the metering valve insert and inhibit the flow of additional second fluid into the inlet chamber while enabling additional first fluid to be drawn 1416 from the front bottle chamber and into the reservoir 52. After a predetermined pressure is reached or a predetermined volume of dispensing fluid is received 1418 within the reservoir, the vacuum within the reservoir is reduced or otherwise stopped 1420, enabling the backflow valve to transition to the closed position, inhibiting 1422 the flow of fluid back into the front bottle chamber, and enabling the ball of the metering device to transition to the first position, inhibiting the flow of fluid back into the second bottle chamber. As can be appreciated, if the predetermined pressure or predetermined volume of dispensing fluid is not reached, the first fluid continues to be drawn 1416 into the reservoir. If the predetermined pressure or volume of dispensing fluid is reached, the ball of the inlet valve is permitted to transition from the open position to the closed position, where the ball of the inlet valve seals 1424 against the third sealing surface and the port is in fluid communication with the outlet channel. With the trigger handle returned to the unactuated position, the trigger handle may be actuated or otherwise depressed 1426 to urge the piston towards the inner wall of the reservoir and dispense fluid through the nozzle, enabling the first fluid and the second fluid to be sequentially pumped or otherwise drawn into the reservoir. As can be appreciated, it is not necessary for the trigger handle to be disposed in the unactuated position before actuating the trigger handle again. It is envisioned that the above-described operation may be performed any number of times without departing from the scope of the disclosure.

In some embodiments, the fluid dispensing device 10 is configured to mix the first fluid and the second fluid entirely in the reservoir 52 to form the dispensing fluid. In some embodiments, the fluid dispensing device 10 is configured to mix the first fluid and the second fluid in a portion other than the reservoir 52 to form the dispensing fluid. A portion other than the reservoir 52 may include a mixing component selected from the group consisting of a void volume, a static mixing element, a dynamic mixing element, and combinations thereof.

In some embodiments, the outlet portion 14 is configured to receive and dispense the dispensing fluid.

In some embodiments, the fluid dispensing device 10 is configured to sequentially pump the first fluid and the second fluid. In these embodiments, the first fluid and the second fluid are sequentially pumped to the reservoir 52, mixed in the reservoir 52 to form the dispensing fluid, and then dispensed from the outlet portion 14.

In some embodiments, the fluid dispensing device 10 includes at least two metering devices. In some embodiments, the fluid dispensing device includes at least three metering devices. In some embodiments, the fluid dispensing device includes more than three metering devices.

In some embodiments, the fluid dispensing device 10 is configured to mix and meter at least two fluids. In some embodiments, the fluid dispensing device 10 is configured to mix and meter at least three fluids. In some embodiments, the fluid dispensing device 10 is configured to mix and meter more than three fluids.

In some embodiments, at least one of the first inlet portion 74 and/or the second inlet portion 78 of the flow chamber 70 comprises a valve that is configured to prevent fluidic backflow. In some embodiments, only the first inlet portion 74 of the flow chamber 70 comprises a valve that is configured to prevent fluidic backflow. In some embodiments, only the second inlet portion 78 of the flow chamber comprises a valve that is configured to prevent fluidic backflow. In some embodiments, both the first inlet portion 74 and the second inlet portion 78 of the flow chamber 70 comprises a valve that is configured to prevent fluidic backflow.

In some embodiments, at least one of the first inlet portion 74 and/or the second inlet portion 78 of the flow chamber 70 does not comprise a valve that is configured to prevent fluidic backflow. In some embodiments, only the first inlet portion 74 of the flow chamber 70 does not comprise a valve that is configured to prevent fluidic backflow. In some embodiments, only the second inlet portion 78 of the flow chamber 70 does not comprise a valve that is configured to prevent fluidic backflow. In some embodiments, neither the first inlet portion 74 nor the second inlet portion 78 of the flow chamber 70 comprise a valve that is configured to prevent fluidic backflow.

The dual chamber bottle 200 may be configured with respect to the dispensing head 12 in a manner known in the art. In some embodiments, the dual chamber bottle 200 is mechanically coupled to the dispensing head 12 with a fitting selected from the group consisting of snap-fittings, screw fittings, and combinations thereof.

### Actuator

Generally, the trigger handle or actuator 48 may be any suitable actuating mechanism or means known in the art. The trigger hander or actuator 48 enables dispensing of the fluid by actuating the pump. In some embodiments, the actuator 48 is a trigger. In some embodiments, the actuator 48 is selected from the group consisting of trigger actuators, mechanical triggers, electrical triggers, trigger engines, pull triggers, push triggers, squeeze triggers, pump actuators, squeeze bottles, and combinations thereof.

### Dip Tubes

In many embodiments, dip tubes 76, 80 may be used in various combinations with the fluid dispensing device 10. In some embodiments, the dip tubes 76, 80 possess an internal diameter that is readily ascertained by its coloration. In some embodiments, the dip tubes 76, 80 do not possess an internal diameter that is readily ascertained by its coloration.

In some embodiments, the fluid dispensing device 10 does not include one or more dip tubes 76, 78. In some embodiments, the fluid dispensing device 10 includes one or more dip tubes 76, 78 integral to the dual chamber bottle 200. In some embodiments, the fluid dispensing device 10 includes a collapsible bag (not shown) inside the dual chamber bottle 200.

In some embodiments, the dip tubes 76, 80 provide ease of identification and installation of variable inner diameter dip tubes 76, 80. The upper portion of the dip tubes 76, 80 may be colored and/or dyed, including to have different colors and/or dyes for different internal diameters of the dip tubes 76, 80. In some embodiments, the first fluid is configured to flow through the first dip tube 76 and the second fluid is configured to flow through the second dip tube 80.

The coloration of the dip tubes 76, 80 is particularly beneficial during manufacture. In some embodiments, the dip tubes 76, 80 may be selected and assembled based on their coloration, which corresponds to their internal diameters. In some embodiments, the combination of a constant outer diameter of the dip tube 76, 80 and a varying inner diameter based on coloration provides adaptability due to a single-size design. This approach reduces cost and time constraints in manufacturing.

In some embodiments, the color of the dip tube 76, 80 may be visualized by human vision and/or machine vision at the time of manufacture to ensure that the dip tubes 76, 80 are fully inserted. This color leads to better quality assurance during the production process by providing a means and system of ensuring the dip tube insertion is complete. For example, the upper portion of the dip tube 76, 80 could be colored red, and the red coloring will no longer visible when the dip tube 76, 80 is fully inserted into the dispensing device 10.

In many embodiments, the diameters of the first dip tube 76 and the second dip 80 tube may be any useful diameter known in the art. In some embodiments, the first dip tube 76 and the second dip tube 80 have substantially similar internal diameters. In some embodiments, substantially similar internal diameters differ by no more than 25%. In some embodiments, substantially similar internal diameters differ by no more than 10%. In some embodiments, substantially similar internal diameters differ by no more than 5%. In some embodiments, substantially similar internal diameters differ by no more than 1%. This aspect enables the fluid dispensing device 10 to be used for a broad range of chemical formulations, including reactive and/or concentrated formulations.

In some embodiments, the first dip tube 76 and the second dip tube 80 have identical or similar outer diameters.

In some embodiments, at least one of the first dip tube 76 and the second dip tube 80 have a diameter of at least 0.5 mm, 0.615 mm, 0.665 mm, 0.775 mm, 0.825 mm, 0.9 mm, 1 mm, 1.5 mm, or 2 mm.

In some embodiments, the first dip tube 76 has a larger diameter than the second dip tube 80. In some embodiments, a ratio of the diameter of the first dip tube 76 and the diameter of the second dip tube 80 is at least 1:1, 2:1, 3:1, 4:1, 5:1, 6:1, 7:1, 8:1, 9:1, or 10:1.

The fluid dispensing device 10 is capable of dispensing a variety of fluids. In some embodiments, a viscosity of the first fluid is different from a viscosity of the second fluid. In some embodiments, the viscosity of the first fluid is identical to the viscosity of the second fluid.

The fluid dispensing device 10 is capable of dispensing a broad range of chemical formulations known in the art. In some embodiments, the fluid dispensing device 10 is configured to dispense a formulation selected from the group consisting of reactive formulations, concentrated formulations, cleaning formulations, cleaning formulations requiring oxidative reactions, formulations for use in organic and/or protein stain removal, formulations for use in mold stain removal, oxidative disinfectant formulations, formulations comprising an organic acid, formulations comprising peracetic acid, diluents, solvents, and combinations thereof. In some embodiments, the fluid dispensing device 10 is configured to dispense a formulation selected from the group consisting of cleaners, household cleaners, bathroom cleaners, kitchen cleaners, glass cleaners, stain cleaners, and combinations thereof.

In some embodiments, the fluid dispensing device 10 is configured to combine a colorless fluid and a colored fluid. In some embodiments, the colorless fluid and the colored fluid do not chemically react. In some embodiments, the colored fluid is replaceable.

Generally, the fluid dispensing 10 device is capable of combining chemical components that require separation until immediately prior to application. For example, the chemical components may be reactive with each other. The combination of such reactive chemistries enables the use of new reactive formulations, such as cleaning and disinfection formulations, that could outperform conventional cleaning and disinfection products.

As another example, it may be desirable to dilute a chemical concentrate immediately before dispensing. In these embodiments, the fluid dispensing device 10 may be used in the application of concentrated formulations, such as concentrated cleaning formulations, where a user only needs to add a diluent (e.g., water) to a refillable side (e.g., the first bottle chamber 204 of a divided bottle (e.g., the dual chamber bottle 200). In some embodiments, the fluid dispensing device 10 draws water from one compartment of a divided bottle at a higher proportion than a cleaning solution in the opposite compartment of the same divided bottle. This operating principle depletes the water compartment more rapidly than the cleaning concentrate side of the bottle. The water portion of the bottle can then be refilled with tap water without the user needing to handle any of the cleaning chemistry. In this way, a shortcoming of most conventional cleaning concentrate technologies is overcome.

In many embodiments, the first fluid and the second fluid may be combined in any suitable proportions. In some embodiments, the first fluid and the second fluid are combined in a ratio in a range of from about 20:1 to about 1:20. In some embodiments, the first fluid and the second fluid are combined in a ratio in a range of about 20:1, about 19:1, about 18:1, about 17:1, about 16:1, about 15:1, about 14:1, about 13:1, about 12:1, about 11:1, about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, or about 1:20.

### Bottle

The bottle is configured to hold separate multiple solutions. In some embodiments, the bottle is a divided bottle with two separate chambers. In some embodiments, the bottle is a divided bottle with more than two separate chambers. In some embodiments, at least one chamber is individually accessible. In some embodiments, each chamber is individually accessible.

In some embodiments, at least one of the chambers is removable from the bottle.

In some embodiments, the two separate chambers may be in the form of separate bottles. In these embodiments, references to a bottle mean the combination of two separate bottles.

In some embodiments, the bottle comprises a plurality of chambers. The plurality of chambers may include two, three, four five, six, or more than six chambers. Each chamber of the plurality of chambers may be of any suitable size (e.g., large or small). Each chamber of the plurality of chambers may be permanent, temporary, replaceable, and/or refillable. Each chamber of the plurality of chambers comprises a distinct fluid. The fluid dispensing device 10 is capable of mixing each of the distinct fluids at desired ratios.

In some embodiments, the fluid dispensing device 10 is configured to mix and meter at least two fluids. In some embodiments, the fluid dispensing device 10 is configured to mix and meter at least three fluids. In some embodiments, the fluid dispensing device 10 is configured to mix and meter more than three fluids. In these embodiments, each fluid may be contained in one or more container. In some embodiments, each fluid is in a separate container.

In some embodiments, the bottle is rotatable with respect to the dispensing head 12. In these embodiments, rotating the bottle with respect to the dispensing head 12 may alter which chamber is aligned with a metering device contained within the dispensing head 12. As a result, the ratio of mixing of the fluids contained in the chamber may change. In the case of two fluids, the ratio of mixing may reverse (e.g., a mixing ratio of 1:3 cleaner to water may reverse to 3:1 cleaner to water).

In some embodiments, at least one chamber of the plurality of chambers is configured to be sealed and filled once by the manufacturer.

In some embodiments, at least one chamber of the plurality of chambers is configured to be refilled once it is empty. This refillable chamber may be configured to comprise water. In these embodiments, the refillable chamber may be repeatably refilled until the other chambers are empty and no further mixing can take place.

In some embodiments, at least one chamber of the plurality of chambers comprises water.

The bottle is capable of containing a broad range of chemical formulations known in the art. In some embodiments, the bottle is configured to contain a formulation selected from the group consisting of reactive formulations, concentrated formulations, cleaning formulations, cleaning formulations requiring oxidative reactions, formulations for use in organic and/or protein stain removal, formulations for use in mold stain removal, oxidative disinfectant formulations, formulations comprising an organic acid, formulations comprising peracetic acid, diluents, solvents, and combinations thereof. In some embodiments, the bottle is configured to contain a formulation selected from the group consisting of cleaners, household cleaners, bathroom cleaners, kitchen cleaners, glass cleaners, stain cleaners, and combinations thereof.

### Method of Manufacture.

The fluid dispensing device 10 may be manufactured according to any suitable method known in the art. In many embodiments, the fluid dispensing device 10 is manufactured by assembling the dual chamber bottle 200 and the dispensing head 12.

In some embodiments, assembling the dual chamber bottle 200 and the dispensing head 12 comprises mechanically coupling the dual chamber bottle 200 to the dispensing head 12 with a fitting selected from the group consisting of snap-fittings, screw fittings, and combinations thereof.

In some embodiments, the method comprises inserting an upper portion of the first dip tube 76 into a portion of the first inlet portion 74 and/or inserting an upper portion of the second dip tube 80 into a portion of the second inlet portion 78.

### Method of Use

The fluid dispensing device 10 may be used according to any suitable method known in the art. In many embodiments, the actuator 48 is actuated to dispense a dispensing fluid from the fluid dispensing device 10.

In some embodiments, the method comprises flowing the first fluid through the first dip tube 76 and flowing the second fluid through the second dip tube 80, wherein the first dip tube 76 and the second dip tube 80 have substantially similar internal diameters. In these embodiments, a small orifice is not required for restricted flow and a corresponding mixing ratio.

In some embodiments, the method comprises mixing the first fluid and the second fluid entirely in the reservoir 52 to form the dispensing fluid.

In some embodiments, the method comprises receiving the dispensing fluid in the outlet portion 14 and dispensing the dispensing fluid from the outlet portion 14.

Embodiments of the present disclosure include:

Embodiment 1. A fluid dispensing device comprising:
a bottle comprising
   a first compartment comprising a first fluid; and
   a second compartment comprising a second fluid; and
a dispensing head comprising:
   an actuator;
   a pump comprising a reservoir;
   a flow chamber comprising a first inlet portion, a second inlet portion, and a metering device that is configured to meter fluid flow; and an outlet portion;
wherein:
   the first inlet portion of the flow chamber is fluidically coupled to the first compartment of the bottle by a first dip tube; and
   the second inlet portion of the flow chamber is fluidically coupled to the second compartment of the bottle by a second dip tube.

Embodiment 2. The fluid dispensing device of Embodiment 1, wherein the fluid dispensing device is configured to mix the first fluid and the second fluid entirely in the reservoir to form a dispensing fluid.

Embodiment 3. The fluid dispensing device of Embodiment 2, wherein the outlet portion is configured to receive and dispense the dispensing fluid.

Embodiment 4. The fluid dispensing device of Embodiment 1, wherein the fluid dispensing device is configured to sequentially pump the first fluid and the second fluid.

Embodiment 5. The fluid dispensing device of Embodiment 1, wherein at least one of the first inlet portion and/or the second inlet portion of the flow chamber comprises a valve that is configured to prevent fluidic backflow.

Embodiment 6. The fluid dispensing device of Embodiment 1, wherein at least one of the first inlet portion and/or the second inlet portion of the flow chamber does not comprise a valve that is configured to prevent fluidic backflow.

Embodiment 7. The fluid dispensing device of Embodiment 1, wherein the metering device comprises a valve that is configured to prevent fluidic backflow and to close when the reservoir of the flow chamber comprises an amount of the first fluid.

Embodiment 8. The fluid dispensing device of Embodiment 7, wherein the metering device comprises a tube comprising the valve, wherein each end of the tube is geometrically restricted to contain the valve within the tube.

Embodiment 9. The fluid dispensing device of Embodiment 8, wherein the tube is configured to determine an amount of the first fluid for mixing with the second fluid.

Embodiment 10. The fluid dispensing device of Embodiment 7, wherein the pump draws the first fluid into the reservoir when the valve is open and wherein the pump draws the second fluid into the reservoir when the valve is closed.

Embodiment 11. The fluid dispensing device of Embodiment 10, wherein the valve opens after being closed when the reservoir is full of a dispensing fluid formed by mixing the first fluid and the second fluid in the reservoir.

Embodiment 12. The fluid dispensing device of Embodiment 10, wherein the valve is more dense than the dispensing fluid.

Embodiment 13. The fluid dispensing device of Embodiment 10, wherein the valve is selected from the group consisting of check valves, ball valves, duckbill valves, and combinations thereof.

Embodiment 14. The fluid dispensing device of Embodiment 1, wherein a viscosity of the first fluid is different from a viscosity of the second fluid.

Embodiment 15. A method of using a fluid dispensing device comprising:
a bottle comprising
   a first compartment comprising a first fluid; and
   a second compartment comprising a second fluid; and
a dispensing head comprising:
   an actuator;
   a pump comprising a reservoir;
   a flow chamber comprising a first inlet portion, a second inlet portion, and a metering device that is configured to meter fluid flow; and
   an outlet portion;
wherein:
   the first inlet portion of the flow chamber is fluidically coupled to the first compartment of the bottle by a first dip tube; and
   the second inlet portion of the flow chamber is fluidically coupled to the second compartment of the bottle by a second dip tube,
the method comprising actuating the actuator to dispense a dispensing fluid from the fluid dispensing device.

Embodiment 16. The method of Embodiment 15, wherein the method comprises flowing the first fluid through the first dip tube and flowing the second fluid through the second dip tube, wherein the first dip tube and the second dip tube have substantially similar internal diameters.

Embodiment 17. The method of Embodiment 15, wherein the method comprises mixing the first fluid and the second fluid entirely in the reservoir to form the dispensing fluid.

Embodiment 18. The method of Embodiment 15, wherein the method comprises receiving the dispensing fluid in the outlet portion and dispensing the dispensing fluid from the outlet portion.

Embodiment 19. A method of manufacturing a fluid dispensing device comprising:
a bottle comprising
   a first compartment comprising a first fluid; and
   a second compartment comprising a second fluid; and
a dispensing head comprising:
   an actuator;
   a pump comprising a reservoir;
   a flow chamber comprising a first inlet portion, a second inlet portion, and a metering device that is configured to meter fluid flow; and
   an outlet portion;
wherein:
   the first inlet portion of the flow chamber is fluidically coupled to the first compartment of the bottle by a first dip tube; and
   the second inlet portion of the flow chamber is fluidically coupled to the second compartment of the bottle by a second dip tube,
the method comprising assembling the bottle and the dispensing head.

Embodiment 20. The method of Embodiment 19, wherein assembling the bottle and the dispensing head comprises mechanically coupling the bottle to the dispensing head with a fitting selected from the group consisting of snap-fittings, screw fittings, and combinations thereof.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated there with. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A fluid dispensing device comprising:
a bottle comprising
a first compartment comprising a first fluid; and
a second compartment comprising a second fluid; and
a dispensing head comprising:
an actuator;
a pump comprising a reservoir;
a flow chamber comprising a first inlet portion, a second inlet portion, and a metering device that is configured to meter fluid flow; and
an outlet portion;
wherein:
the first inlet portion of the flow chamber is fluidically coupled to the first compartment of the bottle by a first dip tube; and
the second inlet portion of the flow chamber is fluidically coupled to the second compartment of the bottle by a second dip tube.

2. The fluid dispensing device of claim 1, wherein the fluid dispensing device is configured to mix the first fluid and the second fluid entirely in the reservoir to form a dispensing fluid.

3. The fluid dispensing device of claim 2, wherein the outlet portion is configured to receive and dispense the dispensing fluid.

4. The fluid dispensing device of claim 1, wherein the fluid dispensing device is configured to sequentially pump the first fluid and the second fluid.

5. The fluid dispensing device of claim 1, wherein at least one of the first inlet portion and/or the second inlet portion of the flow chamber comprises a valve that is configured to prevent fluidic backflow.

6. The fluid dispensing device of claim 1, wherein at least one of the first inlet portion and/or the second inlet portion of the flow chamber does not comprise a valve that is configured to prevent fluidic backflow.

7. The fluid dispensing device of claim 1, wherein the metering device comprises a valve that is configured to prevent fluidic backflow and to close when the reservoir of the flow chamber comprises an amount of the first fluid.

8. The fluid dispensing device of claim 7, wherein the metering device comprises a tube comprising the valve, wherein each end of the tube is geometrically restricted to contain the valve within the tube.

9. The fluid dispensing device of claim 8, wherein the tube is configured to determine an amount of the first fluid for mixing with the second fluid.

10. The fluid dispensing device of claim 7, wherein the pump draws the first fluid into the reservoir when the valve is open and wherein the pump draws the second fluid into the reservoir when the valve is closed.

11. The fluid dispensing device of claim 10, wherein the valve opens after being closed when the reservoir is full of a dispensing fluid formed by mixing the first fluid and the second fluid in the reservoir.

12. The fluid dispensing device of claim 10, wherein the valve is more dense than the dispensing fluid.

13. The fluid dispensing device of claim 10, wherein the valve is selected from the group consisting of check valves, ball valves, duckbill valves, and combinations thereof.

14. The fluid dispensing device of claim 1, wherein a viscosity of the first fluid is different from a viscosity of the second fluid.

15. A method of using a fluid dispensing device comprising:
a bottle comprising
a first compartment comprising a first fluid; and
a second compartment comprising a second fluid; and
a dispensing head comprising:
an actuator;
a pump comprising a reservoir;
a flow chamber comprising a first inlet portion, a second inlet portion, and a metering device that is configured to meter fluid flow; and
an outlet portion;
wherein:
the first inlet portion of the flow chamber is fluidically coupled to the first compartment of the bottle by a first dip tube; and
the second inlet portion of the flow chamber is fluidically coupled to the second compartment of the bottle by a second dip tube,
the method comprising actuating the actuator to dispense a dispensing fluid from the fluid dispensing device.

16. The method of claim 15, wherein the method comprises flowing the first fluid through the first dip tube and flowing the second fluid through the second dip tube, wherein the first dip tube and the second dip tube have substantially similar internal diameters.

17. The method of claim 15, wherein the method comprises mixing the first fluid and the second fluid entirely in the reservoir to form the dispensing fluid.

18. The method of claim 15, wherein the method comprises receiving the dispensing fluid in the outlet portion and dispensing the dispensing fluid from the outlet portion.

19. A method of manufacturing a fluid dispensing device comprising:
a bottle comprising
a first compartment comprising a first fluid; and
a second compartment comprising a second fluid; and
a dispensing head comprising:
an actuator;
a pump comprising a reservoir;
a flow chamber comprising a first inlet portion, a second inlet portion, and a metering device that is configured to meter fluid flow; and
an outlet portion;
wherein:
the first inlet portion of the flow chamber is fluidically coupled to the first compartment of the bottle by a first dip tube; and
the second inlet portion of the flow chamber is fluidically coupled to the second compartment of the bottle by a second dip tube,
the method comprising assembling the bottle and the dispensing head.

20. The method of claim 19, wherein assembling the bottle and the dispensing head comprises mechanically coupling the bottle to the dispensing head with a fitting selected from the group consisting of snap-fittings, screw fittings, and combinations thereof.
